(19) United States
(12) Patent Application Publication
(10) Pub. No.: US 2012/0084853 A1
(43) Pub. Date: Apr. 5, 2012

(54) INFORMATION PROCESSING APPARATUS AND METHOD FOR RESTRICTING ACCESS TO INFORMATION PROCESSING APPARATUS

(75) Inventors: Tomohiro WADA, Tachikawa-shi (JP); Yoshinori KOHMOTO, Ome-shi (JP)

(73) Assignee: KABUSHIKI KAISHA TOSHIBA, Tokyo (JP)

(21) Appl. No.: 13/245,597

(22) Filed: Sep. 26, 2011

(30) Foreign Application Priority Data
Sep. 30, 2010 (JP) 2010-223191

(51) Int. Cl. G06F 21/00

(52) U.S. Cl. 726/16

(57) ABSTRACT

An information processing apparatus includes: a body casing; a first connector provided in the body casing; a setting module; and a security module. The setting module is configured to set a security level to be applied to the information processing apparatus based on a type of a device connected to the first connector. The security module is configured to restrict access to the information processing apparatus according to the set security level.

### CROSS REFERENCE TO RELATED APPLICATION(S)

The present disclosure claims priority to Japanese Patent Application No. 2010-223191 filed on Sep. 30, 2010, which is incorporated herein by reference in its entirety.

### FIELD

An embodiment of the present invention relates to an information processing apparatus and a method for restricting access to an information processing apparatus.

### BACKGROUND

Information processing apparatus as typified by personal computers are in many cases designed with an assumption that they are carried by users. Usually, a notebook personal computer can not only be driven being supplied with external power with an AC adapter connected to it but also be driven being supplied with power from a built-in battery. Designed with the assumption that they are carried by users, personal computers incorporate a security function as typified by a password lock to prevent illegal use by a third person and stealing.

A user uses a personal computer in various manners. For example, a user uses a personal computer that is placed and fixed on a desk, uses it by bringing it to a conference room, or uses it in a moving vehicle by placing it on his or her lap.

It is desired that switching between a security-oriented use mode and a convenience-oriented use mode be made flexibly according to the situation of use of a personal computer.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is an exemplary perspective view showing an appearance of a computer according to an embodiment of the present invention.

FIG. 2 is an exemplary perspective view showing another appearance of the computer according to the embodiment of the invention.

FIGS. 3A and 3B are exemplary schematic sectional views showing how a security lock is attached to the computer in the embodiment of the invention.

FIG. 4 is an exemplary block diagram showing the configuration of the computer according to the embodiment of the invention.

FIG. 5 schematically shows an exemplary security setting screen used in the embodiment of the invention.

FIG. 6 schematically shows an exemplary pop-up message used in the embodiment of the invention.

FIG. 7 shows an exemplary configuration for implementing security functions in the embodiment of the invention.

FIG. 8 is a flowchart of an example procedure of a security level control according to the embodiment of the invention.

### DETAILED DESCRIPTION OF THE EMBODIMENTS

According to one embodiment, an information processing apparatus includes: a body casing; a first connector provided in the body casing; a setting module; and a security module. The setting module is configured to set a security level to be applied to the information processing apparatus based on a type of a device connected to the first connector. The security module is configured to restrict access to the information processing apparatus according to the set security level.

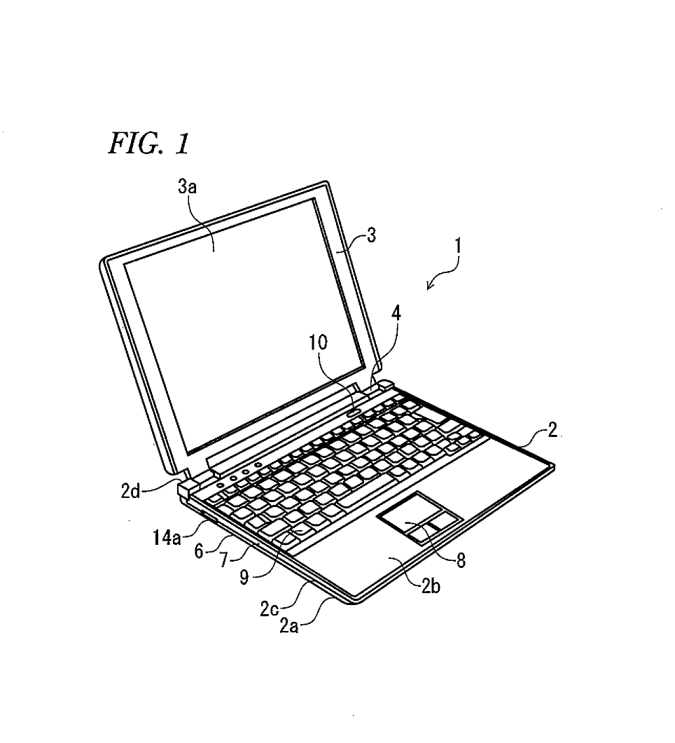

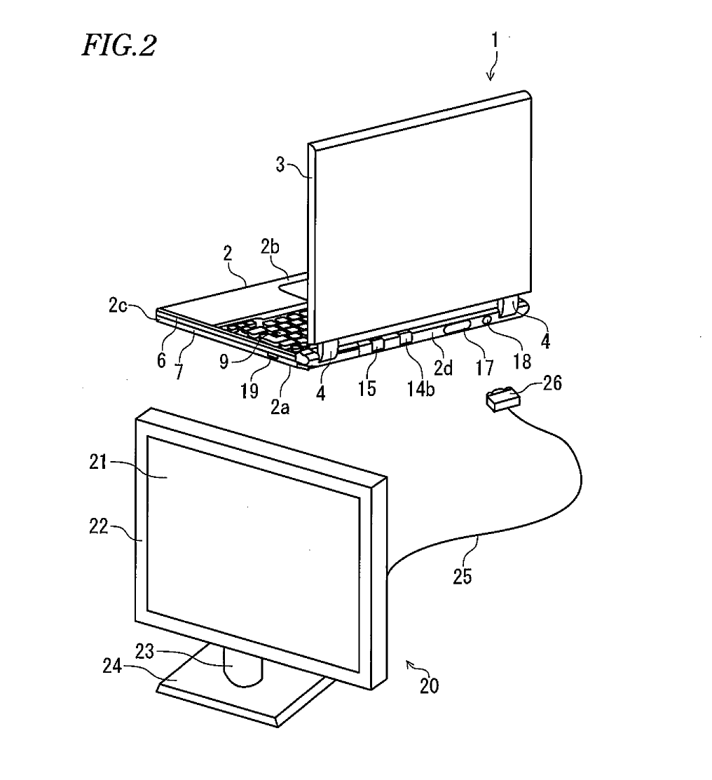

An embodiment of the present invention will be hereinafter described with reference to the drawings. The embodiment is directed to a notebook computer as an example of an information processing apparatus. FIGS. 1 and 2 are exemplary perspective views showing appearances of a computer 1 according to the embodiment of the invention.

The computer 1 has a body casing 2 and a display casing 3. The body casing 2 has a flat box shape having a bottom wall 2a, a top wall 2b, right and left side walls 2c, and a rear wall 2d. The top wall 2b supports a keyboard 9.

The body casing 2 is divided into a base 6 having the bottom wall 2a and a top cover 7 having the top wall 2b. The top cover 7 covers the base 6 from above and is supported by the base 6 detachably.

The display casing 3 is attached rotatably to the body casing 2 via hinges 4. The display casing 3 can be rotated between an open position where it exposes the top wall 2b of the body casing 2 and a closed position where it covers the top wall 2b. A liquid crystal display (LCD) 3a as a display device is incorporated in the display casing 3.

A touchpad 8 and the keyboard 9 for an input operation by the user are attached to the top wall 2b of the body casing 2. A power switch 10 for powering on or off the computer 1 is also provided in the top wall 2b of the body casing 2.

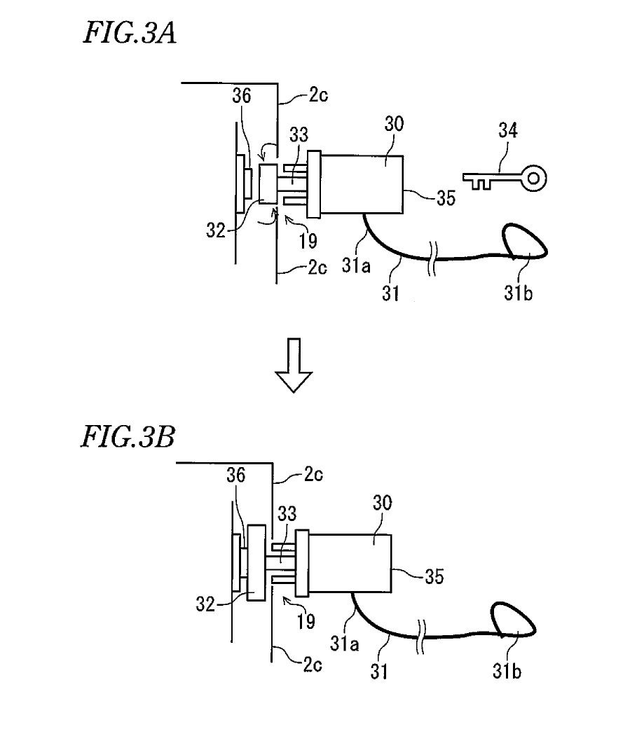

A USB connector 14a to which a USB device is to be connected is provided in the left-hand side wall 2c of the body casing 2. A security slot 19 into which a security lock (see FIGS. 3A and 3B) is to be inserted is provided in the right-hand side wall 2c of the body casing 2.

A LAN connector 15, a USB connector 14b, an RGB connector 17, a DC-IN connector 18 to which an AC adapter is to be connected, and other things are exposed in the rear wall 2d of the body casing 2. In the following description, the USB connector 14a and the USB connector 14b will be written as “USB connector 14” when it is not necessary to discriminate them from each other.

An input device such as a USB mouse or a storage device such as an external hard disk drive (HDD) is to be connected to the USB connector 14.

A LAN cable is to be connected to the LAN connector 15. The computer 1 is connected to a local area network by the LAN cable and is thereby allowed to communicate with another computer connected to the network.

A connector 26 of an external monitor 20 is to be connected to the RGB connector 17. The external monitor 20 is equipped with a display device 21 and a case 22 which houses the display device 21. A pole 23 extends from the case 2 and is supported by a base stage 24. A cable 25 extends from the external monitor 20, and the connector 26 which is provided at one end of the cable is connected to the RGB connector 17. Instead of the external monitor 20, a projector may be connected to the RGB connector 17.

The AC adapter is to be connected to the DC-IN connector 18. When the AC adapter is connected to the DC-IN connector 18, power that is necessary for driving the computer 1 can be obtained from a commercial power line.

FIGS. 3A and 3B are exemplary schematic sectional views showing how the security lock 30 is attached to the computer 1 in the embodiment of the invention. The security lock 30 shown in FIGS. 3A and 3B is a device for preventing stealing of the computer 1. The security lock 30 has a wire 31; that is, one end of the wire 31 is connected to the security lock 30. The security lock 30 is fixed to the computer 1 via the security slot 19. When the other end 31b of the wire 31 is fixed to a desk or the like, the computer 1 cannot be carried out easily.

A latch 32 of the security lock 30 can rotate on a shaft 33. As shown in FIG. 3A, the shaft 33 can be rotated by inserting a key 34 into a key hole 35 and rotating the key 34 in a state that the latch 32 has been inserted into the body casing 2 through the security slot 19. When the shaft 33 has been rotated, the latch 32 cannot be pulled out through the security slot 19 (see FIG. 3B). In the state that the latch 32 cannot be pulled out through the security slot 19, the latch 32 is kept in contact with a detection switch 36. Whether or not the computer is locked by the security lock 30 can be determined by checking the state of the detection switch 36.

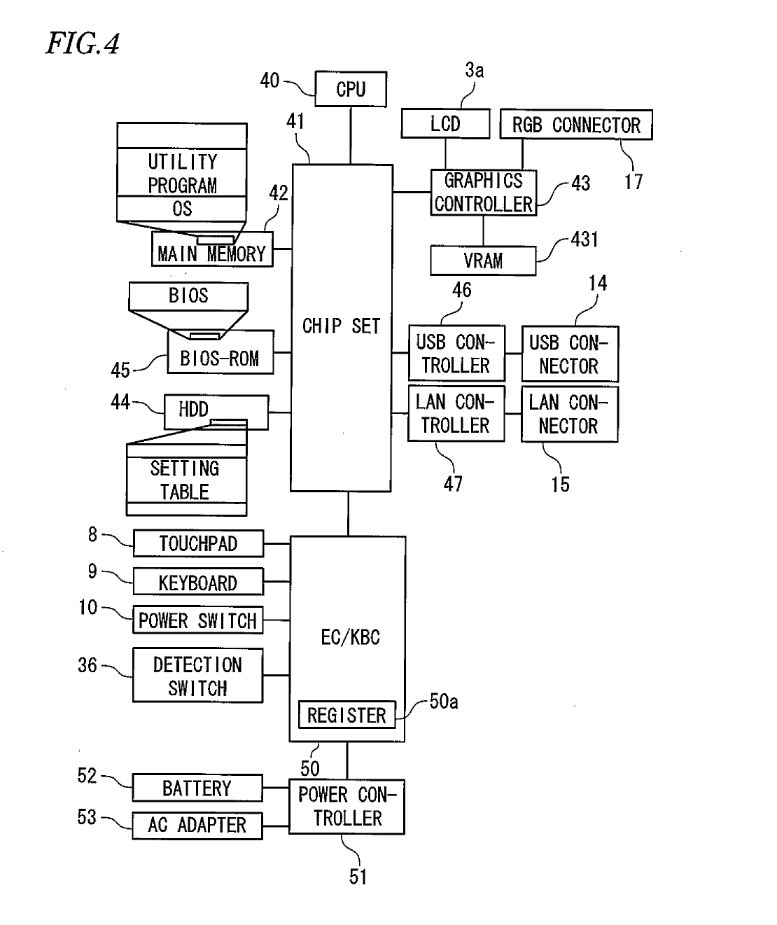

FIG. 4 is an exemplary block diagram showing the configuration of the computer 1 according to the embodiment of the invention. The computer 1 is equipped with a CPU 40, a chip set 41, a main memory (RAM) 42, a graphics controller 43, a hard disk drive (HDD) 44, a BIOS-ROM 45, a USB controller 46, a LAN controller 47, an embedded controller/keyboard controller IC (EC/KBC) 50, the display device 3a, the touchpad 8, the keyboard 9, the power switch 10, the USB connector 14, the LAN connector 15, the detection switch 36, etc.

The CPU 40 is a processor which controls operations of individual components of the computer 1. The CPU 40 runs an operating system and any of various application programs/utility programs that have been loaded into the main memory (RAM) 42 from the HDD 44. The main memory (RAM) 42 is used for storing any of various data buffers.

The CPU 40 also runs a BIOS (basic input/output system) which is stored in the BIOS-ROM 45. The BIOS is programs for hardware control. The BIOS includes BIOS drivers each of which includes plural function execution routines corresponding to plural respective functions for hardware control to provide those functions for the operating system and an application program.

The BIOS also performs processing of reading the operating system from a storage device such as the HDD 44 and developing it in the main memory (RAM) 42 to render the computer 1 in a state that it can be operated by the user.

The chip set 41 is equipped with respective interfaces for interfacing with the CPU 40, the main memory (RAM) 42, and the graphics controller 43. The chip set 41 also performs a communication with each of the USB controller 46, the LAN controller 47, and the EC/KBC 50.

The graphics controller 43 controls the LCD 3a which is used as a display monitor of the computer 1 and the external monitor 20 which is connected to the computer 1 via the RGB connector 17. The graphics controller 43 supplies the LCD 3a or the external monitor 20 with a video signal that corresponds to display data that has been written to a VRAM 431 by the operating system or an application program. Information to the effect that the external monitor 20 has been connected to the RGB connector 17 is sent from the graphics controller 43 to the chip set 41.

The HDD 44 stores the operating system, various application programs/utility programs, and data files.

The USB controller 46 controls a communication with a device connected to the USB connector 14 and the supply of power to the device connected to the USB connector 14. The USB controller 46 detects connection of a device to the USB connector 14 when the connection has been made. Information to the effect that a device has been connected to the USB connector 14 is sent from the USB controller 46 to the chip set 41.

The LAN controller 47 controls a communication with another computer or a server connected to a local area network when a LAN cable is connected to the LAN connector 15. Information to the effect that a LAN cable has been connected to the LAN connector 15 and a communication with a local area network has become possible is sent from the LAN controller 47 to the chip set 41.

The EC/KBC 50 is a one-chip microcomputer in which a controller for power management of the computer 1 and a keyboard controller for controlling the touchpad 8, the keyboard 9, etc. are integrated together.

The EC/KBC 50 cooperates with a power controller 51 to perform processing of powering on or off the computer 1 in response to a user operation of the power switch 10. The power controller 51 supplies power to individual components of the computer 1 using power that is supplied from a built-in battery 52 of the computer 1 or supplied externally via the AC adapter 53. The EC/KBC 50 detects, via the power controller 51, that the AC adapter 53 has been connected to the DC-IN connector 18.

The EC/KBC 50 is equipped with a register 50a. A result of detection of an attachment/detachment status of the security lock 30 by the detection switch 36 is stored in the register 50a.

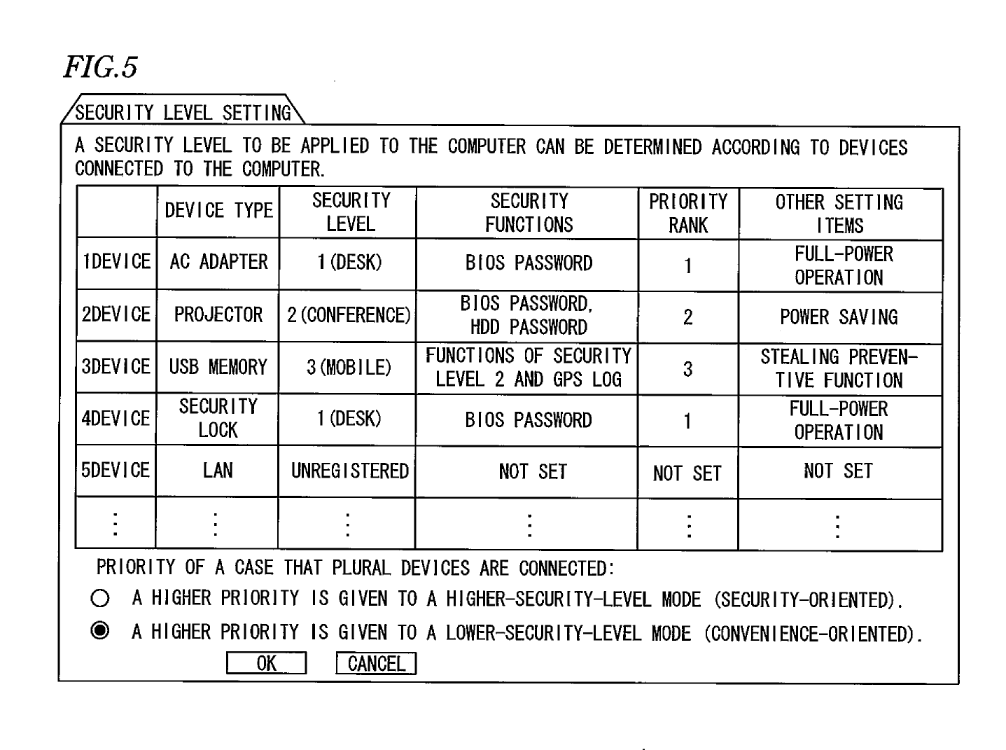

FIG. 5 schematically shows an exemplary device setting user interface used in the embodiment of the invention. In the embodiment, the device setting user interface of FIG. 5 can be presented to the user by means of a utility program.

With the utility program, a security level to be applied to the computer 1 can be set based on information indicating devices connected to the computer 1.

FIG. 5 shows an example that a LAN cable has newly been connected to the computer 1 as a fifth device in a state that the AC adapter 53, a projector, a USB memory, and the security lock 30 are connected to it.

Device types of devices connected to the computer 1 can be determined based on pieces of information that are supplied from the USB controller 46, the LAN controller 47, the graphics controller 43, the EC/KBC 50, and the detection switch 36.

In the embodiment, security levels can be set for respective device types. Three security levels are provided, and the security strength becomes higher as the number representing the security level increases. In the example of FIG. 5, the security level to be applied to the computer 1 is set to “1” when the AC adapter 53 or the security lock 30 is connected to the computer 1. When the AC adapter 53 or the security lock 30 is connected to the computer 1, it is highly probable that the computer 1 is being used on a desk and hence the security level is set to level “1” (lowest security strength). In this case, a BIOS password lock is set as a security function and input of a BIOS password is requested in booting the computer 1 or causing the computer 1 to restore from a sleep mode.

When a projector is connected to the computer 1, it is highly probable that the computer 1 is being used in a conference room that is distant from a desk on which it is placed usually. In this case, the security level is set to “2” (higher in security strength than level “1”) because the computer 1 would be exposed to unauthorized persons more frequently than when it is being used on a desk and persons of other companies may be present. In this case, for example, not only the BIOS password lock but also an HDD password lock is set as a security function.

When a USB memory is connected to the computer 1, it is highly probable that the computer 1 is being used outside the office. In this case, not only are the BIOS password lock and the HDD password lock set but also a movement of the computer 1 is tracked using the GPS and the security level is set to “3” (higher in security strength than level “2”).

Priority ranks prescribe the security level of which device should be applied preferentially when plural devices are connected to the computer 1. For example, when the AC adapter 53 and a projector are connected to the computer 1, there are two security levels (“1” and “2”) that can be applied to the computer 1. Since the AC adapter 53 and the projector have priority ranks “1” and “2,” respectively, the security level “1” of the AC adapter 53 having the higher priority rank is applied to the computer 1.

For another example, when a projector and a USB memory are connected to the computer 1, since the projector and the USB memory have priority ranks “2” and “3,” respectively, the security level “2” of the projector is applied to the computer 1.

In the example of FIG. 5, in the item “priority of a case that plural devices are connected,” “a higher priority is given to a lower-security-level mode (convenience-oriented)” is selected. Therefore, when plural devices having different security levels are connected to the computer 1, a highest priority is given to the security level “1,” a medium priority is given to the security level “2,” and a lowest priority is given to the security level “3.”

Conversely, when “a higher priority is given to a higher-security-level mode (security-oriented)” is selected in the item “priority of a case that plural devices are connected,” a highest priority is given to the security level “3” (highest security strength), a medium priority is given to the security level “2,” and a lowest priority is given to the security level “1.”

Security levels can be set on a device-by-device basis. That is, different security levels can be set for different USB devices. For example, settings can be made so that the security levels “3” and “1” are applied when a USB memory and a USB keyboard are connected, respectively.

As the security strength becomes higher, the effect of preventing illegal use and stealing by an unauthorized person is enhanced. On the other hand, as the security strength becomes lower, the effect of preventing illegal use and stealing by an unauthorized person is lowered but the convenience is increased because, for example, the number of kinds of input-requested passwords is decreased.

When the security strength becomes lower, a user authentication such as biometric authentication may be provided. The biometric authentication is an individual authentication using physical characteristics such a fingerprint and an iris. The biometric authentication does not need devices for a key input or authentication and can easily perform authentication with less actions. For examples, when a user returns from outside where the security level is “3” to the desk where the security level is “1” and connects the AC adapter 53 or the security lock 30, the fingerprint authentication is required to a user before changing security levels. When the fingerprint authentication is completed successfully, the security level is lowered to the level “1.” When the fingerprint authentication is not completed successfully, the security level is maintained as the level “3.” In this way, even when the security level regarding the password input is lowered, by adding the user authentication such as the biometric authentication, the convenience is not undermined and lowering the security level is limited.

Setting can be made of setting items other than the security level, the security functions, and the priority rank. For example, as shown in FIG. 5, when the AC adapter 53 and the security lock 30 are connected to the computer 1 and the security level “1” is applied to it, it is highly probable that the computer 1 is being used on a desk and driven with supply of power from the AC adapter 53. Therefore, in this case, the computer 1 is allowed a full-power operation and a higher priority is thereby given to its performance.

When a projector is connected to the computer 1 and the security level “2” is applied to it, it is highly probable that the computer 1 is being used in a conference room and driven on the battery 52 (the AC adapter 53 is disconnected). Therefore, the computer 1 is rendered in a power saving mode, whereby the battery-drivable time can be elongated.

When a USB memory is connected to the computer 1 and the security level “3” is applied to it, it is highly probable that the computer 1 is being used outside the office. Therefore, a stealing preventive function is set; for example, if a wrong password is input, processing of forcibly disabling a boot of the computer 1 or generating an alarm sound is performed.

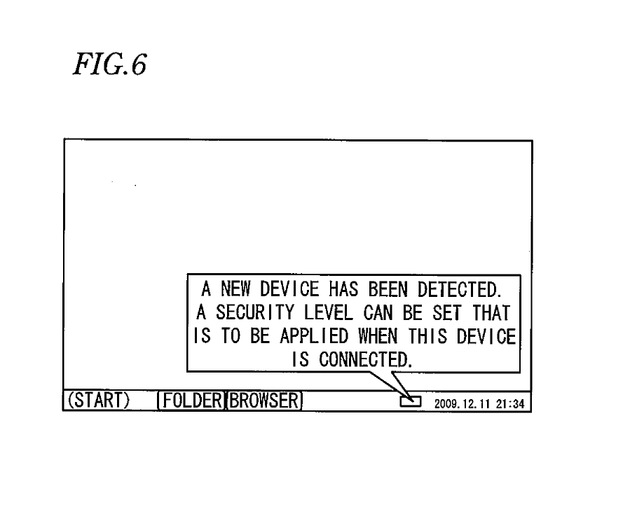

FIG. 6 schematically shows an exemplary pop-up message used in the embodiment of the invention. When connection of an unregistered device to the computer 1 is detected, a pup-up message shown in FIG. 6 is displayed on the LCD 3a. A setting can be made so that the device setting user interface shown in FIG. 5 is displayed on the LCD 3a when this pup-up message is clicked. Naturally, a setting can be made so that this pup-up message is not displayed even if an unregistered device is connected to the computer 1.

Displaying the above pop-up message makes it possible to notify the user that no security level or security functions are set for a device that has been connected to the computer 1 and to urge the user to register a security level and security functions.

In the example of FIG. 5, a LAN cable which is an unregistered device has newly been connected to the computer 1 as a fifth device. The user can set, through the device setting user interface of FIG. 5, a security level, security functions, a priority rank, and other setting items for a case of connection of a LAN cable.

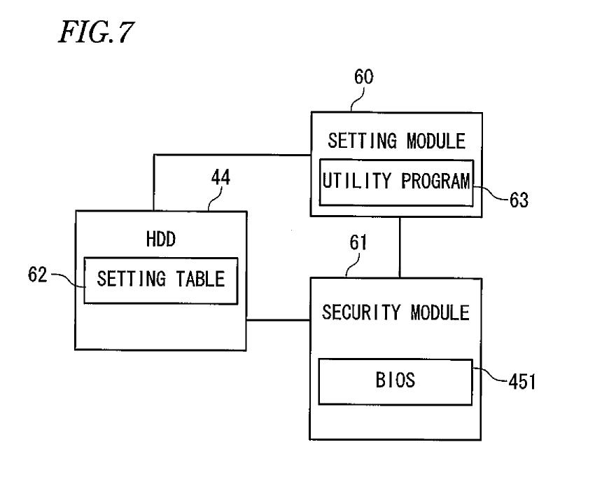

FIG. 7 shows the configuration for implementing security functions in the embodiment of the invention.

In the embodiment, a constituent having a certain unit function is called a module. A module may be implemented by only software, only hardware, only firmware, or an arbitrary combination selected from software, hardware, and firmware.

A security level to be applied to the computer 1 is set by a setting module 60 based on the types of devices connected to the computer 1. In the embodiment, the setting module 60 is centered by the utility program 63 that provides the device setting user interface of FIG. 5.

A security module 61 restricts access to the computer 1 or operation of the computer 1 or causes the computer 1 to perform particular processing according to the security level that has been set by the setting module 60.

The security module 61 includes hardware or firmware for password-locking the HDD 44, an interface for input of an HDD password, a BIOS 451 for a password lock using a BIOS password, and hardware, firmware, or software for tracking a movement of the computer 1 using the GPS. The security module 61 also includes hardware, firmware, or software for performing processing of forcibly disabling a boot of the computer 1 or generating an alarm sound when a wrong password is input to the computer 1. Furthermore, the security module 61 includes other necessary hardware, firmware, and software.

The security module 61 performs necessary processing such as a password lock according to a setting table 62 that has been set by the setting module 60.

The setting module 60 generates a setting table 62 in which a security level, security functions, a priority rank, and other setting items are correlated with each device to be connected to the computer 1. The generated setting table 62 is stored in the HDD 44.

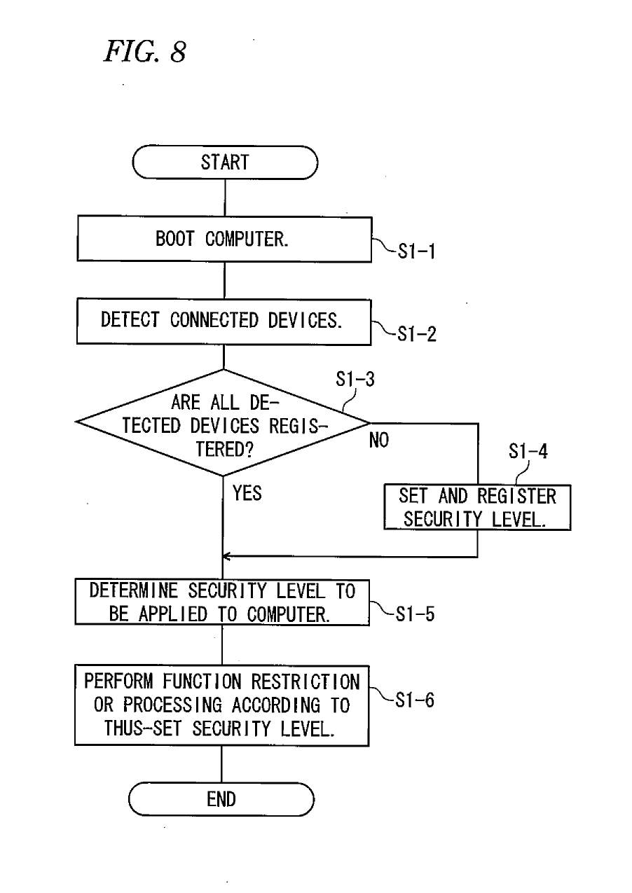

FIG. 8 is a flowchart of an example procedure of a security level control according to the embodiment of the invention.

First, at step S1-1, the computer 1 is booted. At step S1-2, devices that are connected to the computer 1 are detected. At step S1-3, whether each detected device is registered or not is determined through collation. When the detected device(s) include an unregistered one(s) (S1-3: no), at step S1-4 a new security level is set and registered for the unregistered device. As described above with reference to FIG. 5, security functions, a priority rank, and other setting items are set for the unregistered device.

Upon performance of step S1-3 or S1-4, at step S1-5 a security level to be applied to the computer 1 is determined. At step S1-6, access to the computer 1 or operation of the computer 1 is restricted or the computer 1 is caused to perform particular processing according to the thus-set security level.

As described above, the embodiment of the invention can provide an information processing apparatus capable of changing the security strength according to its use situation.

It is to be understood that the present invention is not limited to the specific embodiment described above and that the present invention can be embodied with the components modified without departing from the spirit and scope of the present invention. The present invention can be embodied in various forms according to appropriate combinations of the components disclosed in the embodiment described above. For example, some components may be deleted from the configurations as described as the embodiment.

What is claimed is:

1. An information processing apparatus comprising:
a body casing;
a first connector in the body casing;
a setting module configured to determine a security level based on a type of a device connected to the first connector; and
a security module configured to restrict access to the information processing apparatus according to the security level.

2. The information processing apparatus of claim 1,
wherein the information processing apparatus operates in a first security level when a first device is connected to the first connector, and
wherein the information processing apparatus operates in a second security level when a second device is connected to the first connector, the second security level higher in security strength than the first security level.

3. The information processing apparatus of claim 2,
wherein the setting module is configured to set a priority order, the priority order indicating which of the first security level and the second security level is to be preferentially set when both the first device and the second device are each connected to the first and second connectors respectively.

4. The information processing apparatus of claim 2, further comprising a storage device configured to store a device table, the device table comprising a correspondence between a device to be connected to the first connector and a security level to be applied to the information processing apparatus,
wherein, the setting module is configured to register a new correspondence in the device table between an unregistered device not registered in the device table and a security level to be applied to the information processing apparatus if the unregistered device is connected to the first connector.

5. A method for restricting access to an information processing apparatus, the method comprising:
detecting a type of a device connected to a first connector, the first connector in the information processing apparatus; and
restricting access to the information processing apparatus based on the detected type of the device.

6. The method of claim 5,
wherein a first security level is set to the information processing apparatus when a first device is connected to the first connector, and
wherein a second security level is set to the information processing apparatus when a second device is connected to the first connector, the second security level being higher in security strength than the first security level.

7. The method of claim 6,
wherein the first security level or the second security level is applied to the information processing apparatus based on a priority order, the priority order indicating which of the first security level and the second security level is to be applied when both the first device and the second device are each connected to the first and second connectors respectively.

8. The method of claim 6,
wherein the information processing apparatus comprises a storage device configured to store a device table, the device table comprising a correspondence between a device to be connected to the first connector and a security level to be applied to the information processing apparatus,
and wherein the method further comprises registering a new correspondence in the device table between an unregistered device not registered in the device table and a security level to be applied to the information processing apparatus if the unregistered device is connected to the first connector.
